(19) United States
(12) Patent Application Publication
(10) Pub. No.: US 2025/0371403 A1
(43) Pub. Date: Dec. 4, 2025

(54) AUTOMATED GENERATION OF AUXILIARY QUBITS FOR ERROR CORRECTION

(71) Applicant: Dell Products L.P., Round Rock, TX (US)

(72) Inventors: Brendan Burns Healy, Haddonfield, NJ (US); Miguel Paredes Quiñones, Campinas (BR); Robert A. Lincourt, Franklin, MA (US)

(21) Appl. No.: 18/676,288

(22) Filed: May 28, 2024

(51) Int. Cl. G06N 10/70; G06N 10/20; G06N 10/40

(52) U.S. Cl. CPC G06N 10/70; G06N 10/20; G06N 10/40

(57) ABSTRACT

One example method includes receiving, from a user, a quantum circuit, identifying, in hardware, a QPU (quantum processing unit) for execution of the quantum circuit, transpiling the quantum circuit, determining, based on the transpiling, an excess qubit count X, and based on the excess qubit count X, performing either an error correction process with respect to the quantum circuit, or an error detection process with respect to the quantum circuit. In one example, the method may be performed by middleware that communicates with the user and the hardware.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to error detection and error correction in the execution of quantum circuits. More particularly, at least some embodiments relate to systems, hardware, software, computer-readable media, and methods, for the use of auxiliary qubits for use in error detection and/or error correction in the context of quantum circuit executions.

### BACKGROUND

Gate-based quantum computing is presently in the so-called Noisy, Intermediate-Scale (NISQ) era. This means that QPUs are limited by both their capacity, and noise, which may be a result of decoherence and the fidelity of gate operations. Thus, two large areas of focus by quantum hardware vendors are reducing overall noise, and equivalently improving fidelity of qubits, and also increasing the number of qubits per chip. These advancements are achievable both through software and hardware developments. In this context, the concept of logical qubit is the representation of an error free entity, or an entity with minimum error, that users will use to build complex algorithms. Typically, a logical qubit implies the use of arrays of physical qubits.

Typically, quantum jobs are submitted to the hardware, such as QPUs (quantum processing units) in the form of quantum circuits, that is, sequential instructions to apply a set series of available gates to the set of qubits, which have been initialized to some state, typically |0>. One task for the middleware translating between the quantum job submitted by a user and a QPU is transpilation, which in part involves assigning a set of physical qubit(s) to any given logical qubit. While this process can increase the number of qubits required to execute the circuit from the logical number, which would be the number required on a fully connected, all-to-all, board, it is likely some physical qubits will be left over, that is, unused. At present however, there are no known mechanisms for taking advantage of this excess available QPU capacity.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example architecture, according to one embodiment.

FIG. 2 discloses aspects of an example of 5-1 encoding of physical qubits to logical qubits.

FIG. 3 discloses aspects of an approach for using syndrome qubits for error correction in the execution of a quantum circuit.

FIG. 4 discloses aspects of a method according to one embodiment.

FIG. 5 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to error detection and error correction in the execution of quantum circuits. More particularly, at least some embodiments relate to systems, hardware, software, computer-readable media, and methods, for the use of auxiliary qubits for use in error detection and/or error correction in the context of quantum circuit executions.

One example embodiment comprises a method for identifying, in response to a quantum job received from a user, excess qubits that may be available, and then using those excess qubits for performing an error detection process and/or error correction process. In an embodiment, error detection may be performed by syndrome/auxiliary bits during execution of the quantum job. Analysis, and correction, of detected errors may be performed after execution of the quantum job. One example of such a method may comprise the following operations: determining the number of extra qubits on hardware based on the number of qubits of the circuit that must be executed; obtaining the circuit object and counting the number of cnots where every qubit participates; ranking qubits, by the number of cnots from the maximum to the minimum, to make a determination as to the level of entanglement that a qubit has; relating the distribution of significant qubits – such as the most entangled or most significance to an output bitstring – with the remaining qubits at the hardware; and, performing error correction, or performing error detection when possible according to the number of physical qubits assigned by logical qubit.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that otherwise unused qubits may be employed for error detection and/or error correction processes. An embodiment may provide for more efficient, relative to conventional approaches, use of qubits. An embodiment may improve the fidelity of results obtained from execution of a quantum circuit at no additional cost to a user. An embodiment may identify which qubits, of a group of qubits, may benefit most from an error detection and/or error correction process. Various other advantages of one or more example embodiments will be apparent from this disclosure.

### A. Context for an example embodiment

### A.1 Introduction

Gate-based quantum computing is a non-deterministic process which produces a distribution of probabilities over possible states of a bitstring, where the length of this string is the number of qubits on the hardware. Typically, in order to make use of this distribution, because it is not visible to the user, the distribution is sampled, or ‘measured’ in quantum mechanics parlance, to produce an individual bitstring at a rate commensurate with the associated probabilities. To illustrate, the end state may be 80% |00> + 20% |11> which, when measured, may ideally yield 00 in four out of five runs and 11 in the other, with no outcomes of 10 or 01 unless there is noise in the process. However, noise is commonly encountered in current approaches. As an aside, it is noted that the coefficients involved in this example are complex values, whose moduli squared are the actual probability.

For some algorithms, this indeterminacy at the end of the run is a desired result, while other algorithms may be designed to end as close to 100% of some bitstring as possible. However, in no algorithm is there a desire for noise, which usually manifests as some small probability of any possible bitstring, or the lack of. Indeed, with enough noise, the intended distribution may be drowned out entirely, and the end sampling results merely look like a uniform probability distribution with no statistical significance.

As such, an end user wishes for minimal overall noise. Primarily, the current way to do this is to improve the hardware. Some quantum vendors go so far as to report the fidelity of their qubits and gates, to enable an end user to predict an approximate amount of noise so that the user can make decisions based on this information. However, there are techniques to improve accuracy at the algorithm level as well.

One such way to reduce error in quantum circuit execution is by using so-called auxiliary qubits. These are additional qubits that are not relevant to the computation, but serve some other purpose during the execution of the job. One application of these auxiliary qubits can be for error correction. See https://en.wikipedia.org/wiki/Quantum_error_correction for further information, and see also https://arxiv.org/abs/1907.11157 - both of which are incorporated herein in their respective entireties by this reference. In general, for the purposes of this disclosure, it should be understood that additional physical qubits may, in one example embodiment, be utilized to improve fidelity of results. However for completeness, the discussion herein may refer broadly to various ways in which this utilization of additional physical qubits might be accomplished.

### A.2 Error correction

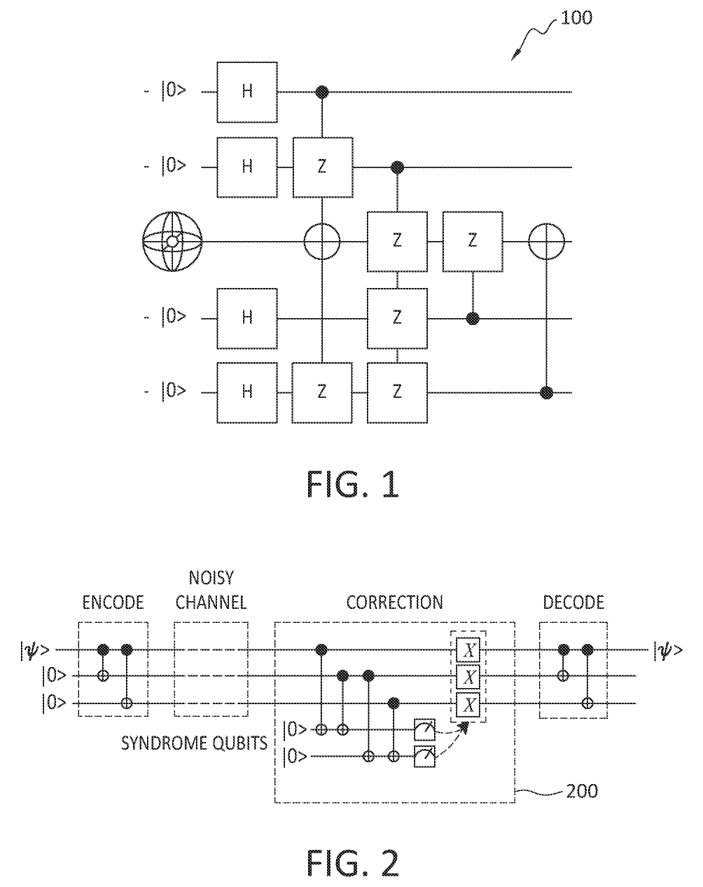

The most complete version of error correction is to perform a process such as Steane coding on every qubit. While this is a robust form of error correction, the overhead cost in performing the Steane process is enormous, requiring, as shown in the example encoding 100 of FIG. 1, at least a 5-to-1 ratio of physical qubits to logical qubits. As such, it is unlikely that, in a given situation, a QPU will happen to have sufficient excess physical qubits to perform Steane coding on every logical qubit, unless the hardware was deliberately chosen for this reason by a user which, in an embodiment, may be offered to users for quantum jobs with sufficiently few logical qubits that remaining excess available qubits are adequate to perform the Steane coding on those logical qubits. As discussed in further detail below, an embodiment may provide real time quantum circuit analysis that may reveal which logical qubits are most error-prone and/or important to the result of the circuit, and based on this information, an embodiment may operate to shadow, or observe and evaluate, only those logical qubits.

As discussed above, the use of Steane coding may not be practical, or possible, in all circumstances. And, in fact, it is also possible to use fewer than five times as many qubits to perform some error correction less robust than Steane coding, but still useful. The auxiliary qubits used in such less precise methods are usually called syndrome qubits as depicted in the example of FIG. 2. This error correction scheme 200 uses dynamic circuits to apply corresponding control gates to a faulty qubit. As collectively illustrated by Steane coding, and the use of auxiliary qubits as shown in the example of FIG. 2, these methods each constitute a tradeoff between (1) how many physical qubits are required and (2) the quality of error correction that is possible. That is, Steane coding for example, provides high quality error correction, but at the cost of potentially a very large number of physical qubits to perform the error correction. On the other hand, the auxiliary qubit approach provides error correction that is not as robust as can be obtained with Steane coding, but which can be obtained with far fewer physical qubits.

The following final example of error correction and/or detection, together with the Steane coding and auxiliary qubit examples, thus collectively illustrate that there is a scale or continuum of error correction quality versus physical qubits required to perform the error correction. In particular, an approach that employs so-called syndrome qubits may occupy the end of this scale opposite the end occupied by Steane coding. This approach, which may be considered as the opposite of Steane encoding, may comprise the use of syndrome/auxiliary qubits for simple error detection, as compared to error correction. In this schema, additional qubits may be used as flags in order to determine when there is unexpected behavior in the portion of the QPU representing the logical qubits. While this level of information loss does not allow the intended states to be restored in execution time, there may still be bits available in the final measurement, indicating whether or not an error has occurred. In the event that those bits indicate an error has occurred with respect to one or more shots, those shots may be thrown out of the final results.

### B. Aspects of an example architecture according to one embodiment

The following is a discussion of aspects of an example architecture according to one embodiment. This discussion is not intended to limit the scope of the claims or this disclosure, or the applicability of the embodiments, in any way.

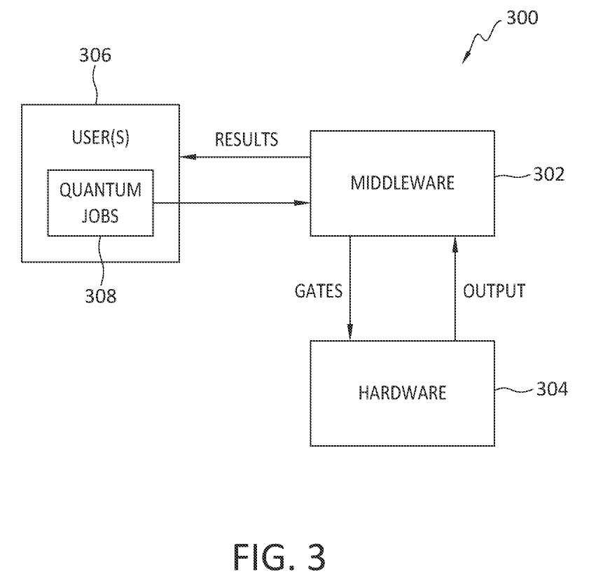

FIG. 3 discloses an example architecture 300 according to one embodiment. The architecture 300 may comprise middleware 302 that communicates with hardware 304, such as qubits for example. As well, the middleware 302 may be configured to receive, from a user 306, one or more quantum jobs 308, each of which may comprise one or more quantum circuits that the user 306 would like to execute using the hardware 304. The hardware 304 may comprise one or more QPUs (quantum processing units) that each comprise respective sets of one or more qubits.

In more detail, the user 306 may submit one or more quantum jobs 308 to the middleware 302. In turn, the middleware 302 may perform a mapping, or transpilation, process in which respective sets of physical qubits of the hardware 304 are assigned to respective logical qubits included in, or implied by, a quantum job 308. That is, the QPU(s) of the hardware 304 may receive, from the middleware 302, a set of gates to apply to physical qubits. After the transpilation, the quantum job 308 may then be executed using the hardware 304, and the results output to the middleware 302, and/or to the user 306. The middleware 302 may then return the results to the user 306.

In one embodiment, the results provided to the user 306 by the middleware 302 may comprise a recommendation, possibly by the middleware 302 for example, as to one or more particular logical qubits of the executed quantum job 308 that may benefit most, relative to other logical qubits of the quantum job 308, from the performance of an error detection process and/or an error correction process. In an embodiment, the results provided to the user 306 by the middleware 302 may comprise an identification or notification, possibly by the middleware 302, that the hardware 304 comprises unused physical qubits that are available for an error detection process and/or an error correction process.

### C. Detailed discussion of aspects of an embodiment

### C.1 Introduction

There are only so many vendors and QPUs available for hire in the landscape, and a user generally cannot request hardware, such as a board, with fewer than necessary qubits, so picking the smallest possible hardware size with an adequate number of qubits will still typically result in some overage, that is, an excess of qubits. Thus, an embodiment comprises an approach in which the middleware may can make use of this extra QPU capacity to improve fidelity of the results of a quantum circuit.

As discussed in connection with FIG. 3, a user who submits a quantum job, or simply ‘job,’ that is, a quantum circuit, to a QPU will have this circuit investigated by the middleware in order to do the transpilation. Typically, but not necessarily always, this QPU will have more physical capacity, that is, physical qubits, than are required to perform the job.

Suppose, for example, that the market has on offer QPUs with capacity 30, 60, and 90, physical qubits. Then, any job submitted that does not require exactly one of these numbers of qubits will by necessity be run by a machine with excess physical qubit capacity. In one embodiment, the middleware will go into the circuit and add additional auxiliary qubits to take advantage of this extra capacity. Because, in one embodiment, this step of adding additional auxiliary qubits comes after the selection of hardware, it can be performed with knowledge of the QPU topology. This enables the middleware to construct auxiliary qubits with the correct connection to the qubits of interest, that should be correct or have faults identified. In an embodiment, the auxiliary qubits may be automatically added to the circuit by the middleware, or other entity, after the hardware has been selected.

In a case where, for example, there are a significant number of excess qubits, the recompilation may make copies of the most important, as identified by a user for example, logical qubits. In one embodiment, the creation and use of these copies may thus enable full error correction, such as by Steane coding for example, of these qubits, instead of, or in addition to, error detection, for those logical qubits.

In a case where, for example, there is only a moderate surplus of qubits, an embodiment may comprise a relatively less precise method for error correction, as exemplified in FIG. 2 and the associated discussion of syndrome qubits. Thus, an embodiment may perform correction of more common errors, giving some improvement of fidelity, although less than an improvement that might be expected to be observed where the surplus of qubits is significant. In this situation, the middleware may also make a determination as to which logical qubits are most in need of error correction. This can be done by analyzing the circuit.

For example, a circuit analysis, according to one embodiment, that some qubits are involved in more 2-qubit gates than others, which may tend to have a significantly higher error rate for conventional QPUs. This means that the correct representation of this qubit will affect the other qubits connected to it. Alternatively, circuit analysis may reveal that the values of certain logical qubits have a relatively higher importance, as compared with other logical qubits, in the overall algorithm. For example, those qubits representing the output of the factorization when running Shor’s algorithm may be relatively more important than other qubits in the quantum circuit.

Finally, in a case where there is only a limited number of surplus qubits, or the circuit to be executed is deep enough to require significant coherence time, then the middleware may, in one embodiment, determine to apply error detection, but not error correction, mechanisms. In this case, which may involve the use of syndrome qubits, there may not be a direct improvement in the fidelity of any given shot, that is, any given execution of the quantum circuit. However, an embodiment may determine, in some cases at least, when there had been an error with a qubit once the final circuit is measured. In such an instance, an embodiment may, in a post-processing procedure for example, throw out that particular shot from the total results, thus improving the aggregate accuracy of the overall distribution of results.

### C.2 Example methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

In one example embodiment, an entity, such as middleware for example, may implement a method for using excess qubits to perform error detection and/or error correction. One example of such a method may comprise the following operations: determining the number of extra qubits on hardware based on the number of qubits of the circuit that must be executed; obtaining the circuit object and counting the number of cnots where every qubit participates; ranking qubits, by the number of cnots from the maximum to the minimum, to make a determination as to the level of entanglement that a qubit has; relating the distribution of significant qubits – such as the most entangled or most significance to an output bitstring – with the remaining qubits at the hardware; and, performing error correction, or performing error detection when possible according to the number of physical qubits assigned by logical qubit.

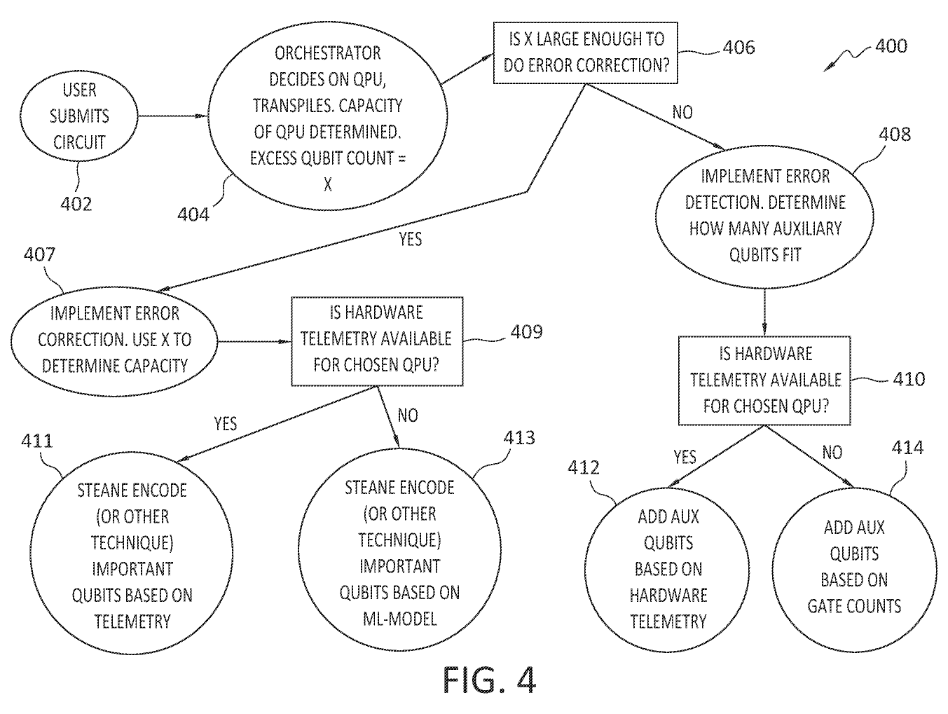

With attention now to the example of FIG. 4, a workflow, or method, according to one particular embodiment is disclosed. This example method is generally indicated at 400 and may be performed by middleware, and/or one or more of the other entities disclosed herein.

The example method 400 may begin when a user submits 402 a quantum circuit, or simply ‘circuit,’ for execution. In an embodiment, the circuit may be submitted 402 to a middleware. The middleware, which may comprise an orchestrator, may perform operations 404 comprising identifying QPUs to execute the circuit, and then transpiling the circuit. The transpilation process may implicate, or result in, a determination of an excess qubit count, which may be set as: excess qubit count = X, where X is any integer equal to or greater than zero.

Next, a check 406 may be performed to determine if X is large enough to support performance of an error correction process. If so, an error correction process may be instantiated 407. The value of X may be used to determine the qubit capacity available to support the error correction process.

A further check 409 may then be performed to determine if hardware telemetry is available for the QPUs selected 404 to execute the circuit. If this telemetry is available, Steane coding, or a comparable technique, may be performed 411, based on that telemetry, for the logical qubits of the selected QPU(s). On the other hand, if the check 409 reveals that no hardware telemetry is available, Steane coding, or a comparable technique, may be performed 413, using a machine learning (ML) model, for the logical qubits of the selected QPU(s). It is noted that in either of the cases 411 and 413, the Steane coding or other process may be limited to only those qubits determined, based on telemetry or an ML model, respectively, to be relatively more important than other qubits of the quantum circuit.

Returning now to the check 406, if it is determined that the value of X is not large enough to support performance of an error correction process, an error detection process may be instantiated 408 and may determine how many auxiliary qubits can be added to the circuit. Next, a further check 410 may be performed to determine whether hardware telemetry is available for the selected 404 QPU(s). If so, one or more auxiliary qubits may be added 412, based on the hardware telemetry, to the circuit. If hardware telemetry is determined 410 not to be available, one or more auxiliary qubits may be added 412, based on a gate count of the circuit.

### C.3 Example alternative embodiment

Another example embodiment implements on-the-fly fractionalization of the QPU in the following way. If a user has submitted multiple circuits, or multiple users have submitted circuits around the same time, and those circuits together fit on the smallest QPU that would execute either one individually, then the circuits could all be run together on the hardware. Dividing the cost of the execution(s) in half, this would save each end-user 50% of their cost, or potentially more if even more circuits fit on the QPU. If the circuits each came with a different number of shots, this savings could be distributed according to that request. To illustrate, 1024 shots requested is assigned 67% of the cost, and 512 shots 33%. Note that in this case, the QPU would still execute the largest number of shots requested, to fulfil all user SLAs (service level agreements). In this implementation, two or more circuits would, in effect, be “glued together” in order to create one large circuit that was fed to the QPU.

A classical server running this process may disaggregate the bitstring results before returning the desired results to the user. This may be done in a manner similar to how the previous implementation description would need to discard the bits corresponding to auxiliary qubits. It may be the case that this fractionality approach, according to one embodiment, may outlive the NISQ era. Indeed, if QPU qubits were nearly-perfect and fully connected, the error correction and detection would be less useful. However, in such a landscape, QPUs are likely to be significantly larger, thus increasing the value of potential fractionalization, an example of which is described above.

Any one or more of the disclosed embodiments may be built on top of the Dell Quantum Computing Solution (DQCS). In this way, the functionality of the DQCS may be further expanded and enhance.

### D. Further discussion

As disclosed herein, one or more embodiments may possess various useful features and aspects, although no embodiment is required to possess any of such features and aspects. The following examples are illustrative of some of such features and aspects.

For example, an embodiment may perform identification and utilization of extra physical qubits that otherwise go to waste. This increases the fidelity of the end-user results at no extra cost to the user, nor any appreciable additional load on the QPU.

As another example, an embodiment may implement sliding-scale “tradeoff” option that may be presented to a user. Instead of simply using extra capacity that happens to exist on a selected machine, a market broker may offer the end user the option to intentionally select an overlarge QPU in order to leverage additional fidelity improvements. This may make sense based on spot pricing of shots on QPUs, and live telemetry could give an indication of the cost/fidelity exchange.

An embodiment may provide real time analysis, such as by middleware, a broker, or matchmaking software, to analyze submitted quantum circuits for the purpose of determining which logical qubits are most valuable to detect/correct errors in. Such an embodiment may then provide a corresponding notification or recommendation to the user.

An embodiment may implement a circuit-altering workflow, an example of which is described above, to aggregate multiple circuits. This approach may, in essence fractionalize the QPU to reduce costs for users. This may be performed for multiple circuits for one user, or for one or more respective circuits from multiple users.

### E. Further Example Embodiments

Following are some further example embodiments. These are presented only by way of example and are not intended to limit the scope of this disclosure or the claims in any way.

Embodiment 1. A method, comprising: receiving, from a user, a quantum circuit; identifying, in hardware, a QPU (quantum processing unit) for execution of the quantum circuit;

transpiling the quantum circuit; determining, based on the transpiling, an excess qubit count X; and based on the excess qubit count X, performing either an error correction process with respect to the quantum circuit, or an error detection process with respect to the quantum circuit.

Embodiment 2. The method as recited in any preceding embodiment, wherein when the excess qubit count X meets or exceeds a threshold, the error correction process is performed.

Embodiment 3. The method as recited in any preceding embodiment, wherein when the excess qubit count X fails to meet a threshold, the error detection process is performed.

Embodiment 4. The method as recited in any preceding embodiment, wherein a real time analysis is performed to determine which logical qubit(s) of the quantum circuit are most valuable, relative to other logical qubit(s) of the quantum circuit, to detect and/or correct errors in.

Embodiment 5. The method as recited in any preceding embodiment, wherein the error correction process comprises performing Steane coding on logical qubits of the quantum circuit.

Embodiment 6. The method as recited in any preceding embodiment, wherein the error correction process, or the error detection process, is performed while the quantum circuit is being executed by the QPU.

Embodiment 7. The method as recited in any preceding embodiment, wherein the error detection process is performed using one or more auxiliary qubits that have been added to the quantum circuit.

Embodiment 8. The method as recited in any preceding embodiment, wherein the error correction process comprises restoring respective intended states of one or more logical qubits of the quantum circuit.

Embodiment 9. The method as recited in any preceding embodiment, wherein the quantum circuit is one of a group of received quantum circuits, and the QPU is a smallest QPU that is able to execute any of the quantum circuits individually.

Embodiment 10. The method as recited in embodiment 9, wherein the quantum circuits are all run together on the QPU, and a total cost to run respective groups of shots of all the quantum circuits is determined based on a number of shots performed for a single one of the quantum circuits as a fraction of a total of all the shots for all the quantum circuits.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In an embodiment, a computer may comprise one or more QPUs, each of which may comprise one or more qubits. An embodiment of a computer may comprise a simulated annealer, and/or an annealer composed of quantum, and/or classical, computing elements.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

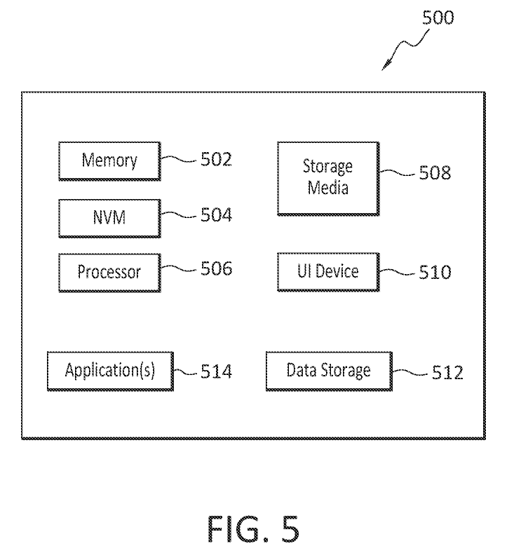

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving, from a user, a quantum circuit;
identifying, in hardware, a QPU (quantum processing unit) for execution of the quantum circuit;
transpiling the quantum circuit;
determining, based on the transpiling, an excess qubit count X; and
based on the excess qubit count X, performing either an error correction process with respect to the quantum circuit, or an error detection process with respect to the quantum circuit.

2. The method as recited in claim 1, wherein when the excess qubit count X meets or exceeds a threshold, the error correction process is performed.

3. The method as recited in claim 1, wherein when the excess qubit count X fails to meet a threshold, the error detection process is performed.

4. The method as recited in claim 1, wherein a real time analysis is performed to determine which logical qubit(s) of the quantum circuit are most valuable, relative to other logical qubit(s) of the quantum circuit, to detect and/or correct errors in.

5. The method as recited in claim 1, wherein the error correction process comprises performing Steane coding on logical qubits of the quantum circuit.

6. The method as recited in claim 1, wherein the error correction process, or the error detection process, is performed while the quantum circuit is being executed by the QPU.

7. The method as recited in claim 1, wherein the error detection process is performed using one or more auxiliary qubits that have been added to the quantum circuit.

8. The method as recited in claim 1, wherein the error correction process comprises restoring respective intended states of one or more logical qubits of the quantum circuit.

9. The method as recited in claim 1, wherein the quantum circuit is one of a group of received quantum circuits, and the QPU is a smallest QPU that is able to execute any of the quantum circuits individually.

10. The method as recited in claim 9, wherein the quantum circuits are all run together on the QPU, and a total cost to run respective groups of shots of all the quantum circuits is determined based on a number of shots performed for a single one of the quantum circuits as a fraction of a total of all the shots for all the quantum circuits.

11. A non-transitory storage medium having stored therein instructions that are executable by one or more hardware processors to perform operations comprising:
receiving, from a user, a quantum circuit;
identifying, in hardware, a QPU (quantum processing unit) for execution of the quantum circuit;
transpiling the quantum circuit;
determining, based on the transpiling, an excess qubit count X; and
based on the excess qubit count X, performing either an error correction process with respect to the quantum circuit, or an error detection process with respect to the quantum circuit.

12. The non-transitory storage medium as recited in claim 11, wherein when the excess qubit count X meets or exceeds a threshold, the error correction process is performed.

13. The non-transitory storage medium as recited in claim 11, wherein when the excess qubit count X fails to meet a threshold, the error detection process is performed.

14. The non-transitory storage medium as recited in claim 11, wherein a real time analysis is performed to determine which logical qubit(s) of the quantum circuit are most valuable, relative to other logical qubit(s) of the quantum circuit, to detect and/or correct errors in.

15. The non-transitory storage medium as recited in claim 11, wherein the error correction process comprises performing Steane coding on logical qubits of the quantum circuit.

16. The non-transitory storage medium as recited in claim 11, wherein the error correction process, or the error detection process, is performed while the quantum circuit is being executed by the QPU.

17. The non-transitory storage medium as recited in claim 11, wherein the error detection process is performed using one or more auxiliary qubits that have been added to the quantum circuit.

18. The non-transitory storage medium as recited in claim 11, wherein the error correction process comprises restoring respective intended states of one or more logical qubits of the quantum circuit.

19. The non-transitory storage medium as recited in claim 11, wherein the quantum circuit is one of a group of received quantum circuits, and the QPU is a smallest QPU that is able to execute any of the quantum circuits individually.

20. The non-transitory storage medium as recited in claim 19, wherein the quantum circuits are all run together on the QPU, and a total cost to run respective groups of shots of all the quantum circuits is determined based on a number of shots performed for a single one of the quantum circuits as a fraction of a total of all the shots for all the quantum circuits.
